(19) United States
(12) Patent Application Publication
(10) Pub. No.: US 2024/0232582 A1
(43) Pub. Date: Jul. 11, 2024

(54) APPARATUS AND METHOD FOR SECURE DEEP-LEARNING MODEL SERVICE

(71) Applicant: ELECTRONICS AND TELECOMMUNICATIONS RESEARCH INSTITUTE, Daejeon (KR)

(72) Inventors: Dong-Hyun KIM, Daejeon (KR); Nam-Hyeong KIM, Daejeon (KR); Sang-Hun KIM, Sejong-si (KR); Yo-Han LIM, Yongin-si (KR)

(21) Appl. No.: 18/491,172

(22) Filed: Oct. 20, 2023

(30) Foreign Application Priority Data
Jan. 9, 2023 (KR) 10-2023-0002685

(51) Int. Cl. G06N 3/0455; H04L 9/00

(52) U.S. Cl. CPC G06N 3/0455; H04L 9/008

(57) ABSTRACT

Disclosed herein are an apparatus and method for a secure online deep-learning model service. A client apparatus for the secure online deep-learning model service includes memory in which a secure input network and a secure output network generated in advance based on a deep-learning model provided from a server and at least one program are recorded and a processor for executing the program. The program may perform generating an input vector by passing user data through the secure input network, transmitting the input vector to the server, receiving an output vector acquired by passing the input vector through the hidden network of the deep-learning model from the server, and generating output data by passing the received output vector through the secure output network.

### CROSS REFERENCE TO RELATED APPLICATION

This application claims the benefit of Korean Patent Application No. 10-2023-0002685, filed Jan. 9, 2023, which is hereby incorporated by reference in its entirety into this application.

### BACKGROUND OF THE INVENTION

### 1. Technical Field

The disclosed embodiment relates to deep-learning model service technology.

### 2. Description of Related Art

Currently, deep-learning model parameters are increasing in order to provide improved performance, and the amounts of data for generating a model are also increasing. Accordingly, only a limited number of companies can generate and provide such models.

However, because some user enterprises demand higher performance in specific domains, domain-specific tuning is continuously required. Here, because data used for domain-specific tuning and service is sensitive to information leakage, security is required in more and more cases.

It is commonly known that all online service companies usually identify users and use input information in order to make a series of patterns based on the input information and do marketing based thereon. Accordingly, when deep-learning models of online service companies are used, a method for protecting user information is required.

Recently, methods for modeling deep-learning in a secure state have been actively researched, and a homomorphic encryption method is one of such methods. This method enables operations used for deep-learning, such as addition, multiplication, and the like, to be performed in the same manner even when operations are performed using encrypted values, and a desired result may be acquired by passing encrypted input values through a deep-learning network and decrypting the output.

However, this method has problems in which dimensions are greatly increased for encryption and in which decryption becomes impossible when internal noise exceeds a certain threshold after repeated multiplication operations. Also, a reboot process and time are required in order to remove the increasing noise, accuracy is decreased due to operation estimation in a nonlinear network, and the increasing number of multiplication operations results in a decrease in speed. Therefore, studies for solving these problems are continuously being conducted.

As another method, there is a federated learning method. In this method, modeling is performed using user data by transmitting a model of a central server to each user device or local server. Then, parameters of the model of each user are transmitted to the central server, whereby the single model is updated. This is a method in which security is ensured because only the parameters of the model rather than the user data are transmitted to the central server. However, it is difficult to make a global optimization model because pieces of updated model information of multiple users are combined into a model of a central server, and there is a concern that the model of the central server can be contaminated by users in a training process. Also, local devices are burdened with the entire operation for the model.

### SUMMARY OF THE INVENTION

An object of the disclosed embodiment is to propose a secure service method in which multiple users are able to use a common deep-learning model, which is managed by a service company, online.

Another object of the disclosed embodiment is to prevent a service company from reconstructing original data from information input by a user.

A further object of the disclosed embodiment is to process input data using a deep-learning network of a service company.

Yet another object of the disclosed embodiment is to prevent, when input data is transferred to a deep-learning network of a service company and output from the network, the service company from interpreting the output result.

A client apparatus for a secure online deep-learning model service according to an embodiment includes memory in which a secure input network and a secure output network generated in advance based on a deep-learning model or part thereof provided from a server and at least one program are recorded and a processor for executing the program. The program may perform generating an input vector by passing user data through the secure input network, transmitting the input vector to the server, receiving an output vector, acquired by passing the input vector through the hidden network of the deep-learning model, from the server, and generating output data by passing the received output vector through the secure output network.

Here, when generating the secure input network and the secure output network, the program may perform changing the input network and output network of the deep-learning model provide from the server to be user-private after fixing the hidden network of the deep-learning model, fine-tuning the deep-learning model using user-private data in the state in which the input network and the output network are changed, and storing the input network and the output network of the fine-tuned deep-learning model in the memory as the secure input network and the secure output network.

Here, when changing the input network and the output network, the program may add a user-private network to each of the input network and the output network and change the output unit of the output network to an output unit set by a user.

Here, when generating the secure input network and the secure output network, the program may perform changing the deep-learning model to be user-private, transmitting the hidden network of the deep-learning model changed to be user-private to the server, and storing the input network and output network of the user-private deep-learning model in the memory as the secure input network and the secure output network.

Here, when changing the deep-learning model, the program may change the order of the vector elements of the deep-learning model to an order set by a user and change the order of weight elements by synchronizing the same with the changed order of the vector elements.

Here, the program may scale all of the weights of the deep-learning model by multiplying the weights by constant A and adding constant B.

Here, when generating the secure input network and the secure output network, the program may perform changing the order of the vector elements of the input network of the deep-learning model and the order of the weight elements of a first hidden layer to an order set by a user by synchronizing the order of the vector elements with the order of the weight elements, reducing the number of nodes at which the input network meets the first hidden layer, changing the order of the weight elements of a last hidden layer and the order of the vector elements of the output network of the deep-learning model to an order set by the user by synchronizing the order of the weight elements with the order of the vector elements, reducing the number of nodes at which the last hidden layer meets the output network, changing the output unit of the output network to an output unit set by the user, generating a user-private output network in which the order of output nodes is an order set by the user, fine-tuning the deep-learning model using user data in the state in which the hidden network, excluding the first hidden layer and the last hidden layer, is fixed, and storing the input network and output network of the fine-tuned deep-learning model in the memory as the secure input network and the secure output network. When receiving the output vector, the output vector may be acquired by passing through the hidden network with which the first hidden layer and last hidden layer of the fine-tuned deep-learning model are combined.

Here, the program may use the input network and output network of the deep-learning model provided from the server, rather than using the secure input network and the secure output network, and may further perform performing homomorphic encryption on the input vector before transmitting the input vector to the server; and decrypting the received output vector.

A server apparatus for a secure online deep-learning model service according to an embodiment includes memory in which at least one program and a deep-learning model are recorded and a processor for executing the program. The program may perform receiving a securely processed input vector from a client, generating an output vector by passing the received input vector through the hidden network of the deep-learning model, and transmitting the generated output vector to the corresponding client.

Here, the program may be connected with a client requesting fine-tuning, thereby supporting fine-tuning in the state in which the input network and output network of the client are combined with the hidden network online.

Here, the memory may store a hidden network transmitted from each of one or more clients, and when the output vector is generated, the output vector may be generated through the hidden network transmitted by the client that transmits the input vector.

Here, the program may combine a first hidden layer and a last hidden layer, which are transmitted from a client requesting fine-tuning, with remaining part of the hidden network and support fine-tuning in the state in which the input network and output network of the client requesting fine-tuning are combined with the hidden network online by being connected with the client. When generating the output vector, the program may generate the output vector through the hidden network, including the first hidden layer and the last hidden layer that are fine-tuned by the client that transmits the input vector.

Here, the deep-learning model is a transformer model, and the program may support fine-tuning after being combined online with the input network and output network of a client requesting fine-tuning by being connected with the client in the state in which a first hidden layer of an encoder network, a last hidden layer of a decoder network, and an input layer of the decoder network, which are transmitted from the client requesting fine-tuning, are combined with the encoder network and the decoder network. When generating the output vector, the program may perform first generating the output vector through the encoder network and the decoder network combined with the first hidden layer of the encoder network and the last hidden layer of the decoder network that are fine-tuned by the client that transmits a first input vector; and again generating the output vector through the decoder network that is combined with the input layer of the decoder network and the last hidden layer of the decoder network by the client that transmits a second input vector generated from the previously generated output vector, and again generating the output vector may be repeatedly performed.

A method for a secure online deep-learning model service, in which a secure input network and a secure output network are generated in advance based on a deep-learning model provided from a server, may include generating an input vector by passing user data through the secure input network, transmitting the input vector to the server, receiving an output vector acquired by passing the input vector through the hidden network of the deep-learning model from the server, and generating output data by passing the received output vector through the secure output network.

Here, the secure input network and the secure output network may be generated by changing the input network and output network of the deep-learning model provided from the server to be user-private after fixing the hidden network of the deep-learning model, fine-tuning the deep-learning model using user-private data in the state in which the input network and the output network are changed, and storing the input network and the output network of the fine-tuned deep-learning model in memory as the secure input network and the secure output network.

Here, changing the input network and the output network may comprise adding a user-private network to each of the input network and the output network and changing the output unit of the output network to an output unit set by a user.

Here, the secure input network and the secure output network may be generated in advance by changing the deep-learning model to be user-private, transmitting the hidden network of the deep-learning model changed to be user-private to the server, and storing the input network and output network of the user-private deep-learning model in memory as the secure input network and the secure output network.

Here, changing the deep-learning model may comprise changing the order of the vector elements of the deep-learning model to an order set by a user and changing the order of weight elements by synchronizing the same with the changed order of the vector elements.

Here, changing the deep-learning model may comprise scaling all of the weights of the deep-learning model by multiplying the weights by constant A and adding constant B.

Here, the secure input network and the secure output network may be generated in advance by changing the order of the vector elements of the input network of the deep-learning model and the order of the weight elements of a first hidden layer to an order set by a user by synchronizing the order of the vector elements with the order of the weight elements, reducing the number of nodes at which the input network meets the first hidden layer, changing the order of the weight elements of a last hidden layer and the order of the vector elements of the output network of the deep-learning model to an order set by the user by synchronizing the order of the weight elements with the order of the vector elements, reducing the number of nodes at which the last hidden layer meets the output network, changing the output unit of the output network to an output unit set by the user, generating a user-private output network in which the order of output nodes is an order set by the user, fine-tuning the deep-learning model using user data in the state in which a hidden network, excluding the first hidden layer and the last hidden layer, is fixed, and storing the input network and output network of the fine-tuned deep-learning model in memory as the secure input network and the secure output network. When receiving the output vector, the output vector may be acquired by passing through the hidden network with which the first hidden layer and last hidden layer of the fine-tuned deep-learning model are combined.

Here, the input network and output network of the deep-learning model provided from the server, rather than the secure input network and the secure output network, may be used, and the method may further include performing homomorphic encryption on the input vector before transmitting the input vector to the server; and decrypting the received output vector.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic block diagram of a system for a secure online deep-learning model service according to an embodiment;

FIG. 2 is a schematic signal flowchart for explaining a method for a secure online deep-learning model service according to a first embodiment;

FIG. 3 is a signal flowchart for explaining a step of generating a secure input network and a secure output network according to the first embodiment;

FIG. 4 is a schematic signal flowchart for explaining a method for a secure online deep-learning model service according to a second embodiment;

FIG. 5 is a signal flowchart for explaining a step of generating a secure input network and a secure output network according to the second embodiment;

FIG. 6 is an exemplary view for explaining a change of a deep-learning model to a user-private secure model according to the second embodiment;

FIG. 7 is a schematic signal flowchart for explaining a method for a secure online deep-learning model service according to a third embodiment;

FIG. 8 is a flowchart for explaining a step of generating a secure input network and a secure output network according to the third embodiment;

FIG. 9 is an exemplary view for explaining a change of the input/output network and hidden network of a deep-learning model according to the third embodiment;

FIG. 10 is a schematic signal flowchart for explaining the case in which the method for a secure online deep-learning model service according to the third embodiment is applied to a transformer;

FIG. 11 is a schematic signal flowchart for explaining a method for a secure online deep-learning model service according to a fourth embodiment; and

FIG. 12 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

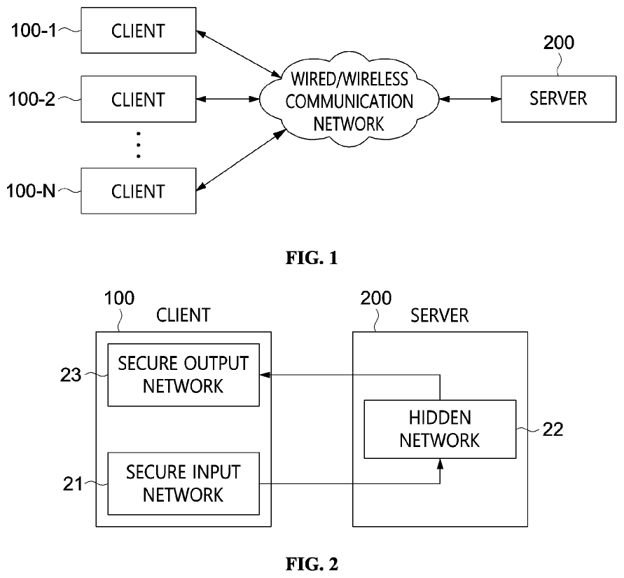

Hereinafter, an apparatus and method for a secure online deep-learning model service according to an embodiment will be described in detail with reference to FIGS. 1 to 12.

FIG. 1 is a schematic block diagram of a system for a secure online deep-learning model service according to an embodiment.

Referring to FIG. 1, the system for a secure online deep-learning model service according to an embodiment may be configured such that multiple clients 100-1, 100-2, . . . , 100-N are connected with a server 200 over wired/wireless communication networks.

The server 200 provides information, such as images, voice, text, and the like input by users through the clients 100-1, 100-2, . . . , 100-N, and online services, such as recognition, translation, and interpretation using the input information, based on a deep-learning model.

Here, the online services, which are useful in an environment in which it is difficult to use a high-performance deep-learning model having many parameters through an embedded terminal or a local network service, are required to process the results of the online services in a secure manner, without exposing the results outside.

To this end, in an embodiment, the clients 100-1, 100-2, . . . , 100-N receive input data, transmit input vectors acquired by processing the input data based on the input network of a deep-learning model to the server 200, receive interpretation results output from the server 200, and process the output network of the deep-learning model. Also, the server 200 inputs the input vectors received from the clients 100 to the hidden network of the deep-learning model and returns results interpreted by the hidden network to the clients 100-1, 100-2, . . . , 100-N.

That is, the input network for generating an input vector by processing input data, for which security is required, and the output network for interpreting an output vector are handled in the clients 100-1, 100-2, . . . , 100-N to be user-private, and only the hidden network, which is an intermediate network of the deep-learning model, is handled by the server 200 of a service company.

The present disclosure may have various embodiments depending on the method of generating an input network, an output network, and a hidden network and the structures thereof. The respective embodiments will be described in detail below.

### First Embodiment

FIG. 2 is a schematic signal flowchart for explaining a method for a secure online deep-learning model service according to a first embodiment.

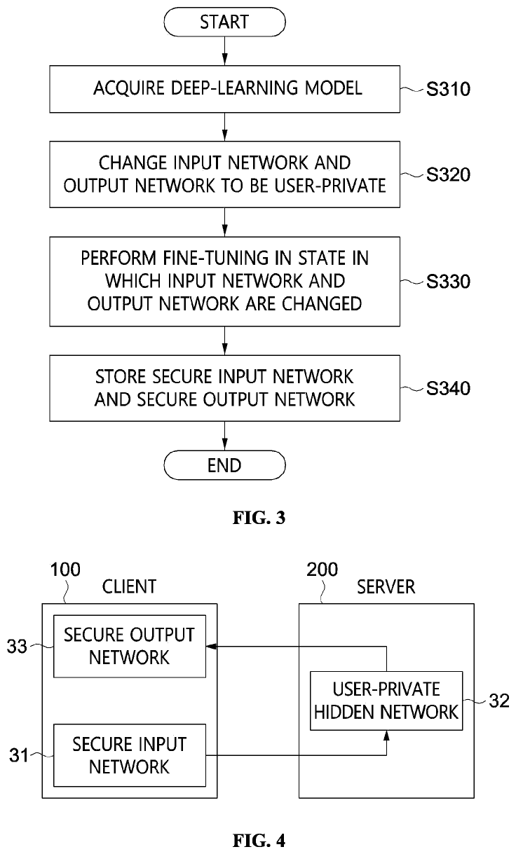

Referring to FIG. 2, in the method for a secure online deep-learning model service according to the first embodiment, a client 100 may generate a secure input network 21 and a secure output network 23 in advance based on a deep-learning model provided from a server 200. This will be described in detail later with reference to FIG. 3.

Subsequently, the client 100 performs generating an input vector by passing user data through the secure input network 21 and transmitting the input vector to the server.

Then, the server 200 performs generating an output vector by passing the input vector received from the client 100 through the hidden network 22 of the deep-learning model and transmitting the generated output vector to the client 100.

Then, the client 100 may perform receiving the output vector from the server 200 and generating output data by passing the received output vector through the secure output network 23.

FIG. 3 is a signal flowchart for explaining the step of generating a secure input network and a secure output network according to the first embodiment.

Referring to FIG. 3, after acquiring a deep-learning model from a server 200 at step S310, a client 100 may perform changing the input network and output network of the acquired deep-learning model to be user-private after fixing the hidden network of the deep-learning model at step S320, fine-tuning the deep-learning model using user-private data at step S330 in the state in which the input network and output network are changed, and storing the input network and output network of the fine-tuned deep-learning model in memory as a secure input network and a secure output network at step S340.

Here, when the input network and output network are changed at step S320, a user-private network is added to each of the input network and the output network, and the output unit of the output network may be changed to an output unit set by a user. That is, not the input vector generation method used by the model provided from the server 200 but an input vector generation method specific to the client 100 is applied. To this end, software settings have to be supported such that the user-private network is added to the input network and the output network in the client 100 and such that the output unit of the output network is changed to the output unit set by the user.

Here, when the deep-learning model is fine-tuned at step S330, the hidden network is not changed by being fixed, and only parameters in the input network and the output network are updated, whereby the deep-learning model is optimized.

Here, in order to tune the deep-learning model, additional training data for the service domain intended to be used by the user is required. The greater the amount of training data, the higher the levels of security and accuracy that can be achieved.

Here, in order to enable fine-tuning using the additional training data of the user, the server 200 may support an additional training process in conjunction with the client 100. That is, the server 200 is connected with the client 100 requesting fine-tuning, and supports fine-tuning in the state in which the input network and output network of the client 100 are combined with the hidden network online.

Accordingly, a service may take a form in which only the hidden network can be used and in which the user-private vectors and networks processed in the input network and the output network are prevented from being exposed to the service company. That is, the online service company is not able to use user information because it knows neither the method of generating the input vector nor the method of interpreting the output data.

The first embodiment is a method in which security is achieved using the method of generating a model suitable for input and output through fine-tuning. That is, although a common hidden network is used, input and output networks are fine-tuned to be used exclusively by a user, unlike the existing input and output networks, whereby only the user who knows information about the input and output is able to use the networks.

This is the same as a method of using the fixed hidden network of an online service as a common network for multiple tasks, as in a voice recognition model for supporting a multilingual model, which is configured to output text in language A in response to the input of a signal of language A and to output text in language B in response to the input of a signal of language B. Such a multilingual model successfully serves as a hidden network even when new language other than the language used for generating the model is input, and it takes a form in which the common hidden network is used for an online service by connecting the same with the user-private input and output networks.

### Second Embodiment

FIG. 4 is a schematic signal flowchart for explaining a method for a secure online deep-learning model service according to a second embodiment.

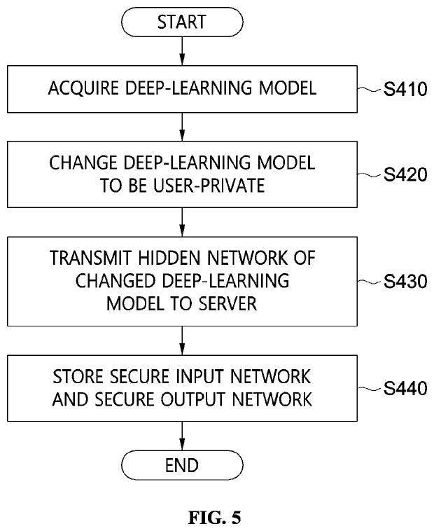

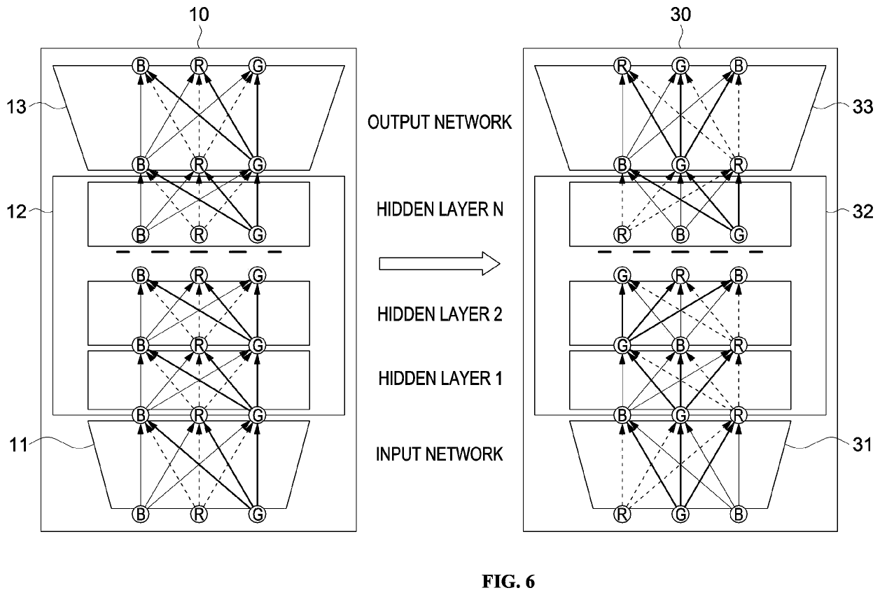

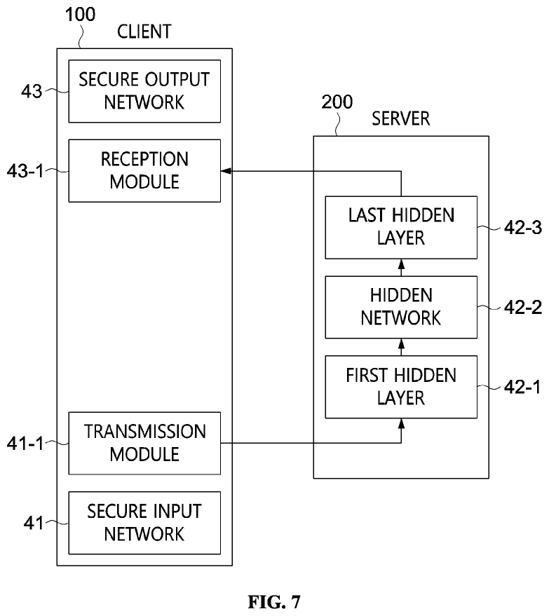

Referring to FIG. 4, in the method for a secure online deep-learning model service according to the second embodiment, a client 100 may generate a secure input network 31 and a secure output network 33 in advance based on a deep-learning model provided from a server 200. This will be described in detail later with reference to FIG. 5 and FIG. 6.

Subsequently, the client 100 performs generating an input vector by passing user data through the secure input network 31 and transmitting the input vector to the server.

Then, the server 200 performs generating an output vector by passing the input vector received from the client 100 through a user-private hidden network 32 and transmitting the generated output vector to the client 100. That is, because the server 200 has stored the user-private hidden network for each client in advance, it detects the user-private hidden network corresponding to the input vector received from the client and processes the input vector using the detected user-private hidden network.

Then, the client 100 may perform receiving the output vector from the server 200 and generating output data by passing the received output vector through the secure output network 33.

FIG. 5 is a signal flowchart for explaining the step of generating a secure input network and a secure output network according to the second embodiment, and FIG. 6 is an exemplary view for explaining a change of a deep-learning model to a user-private secure model according to the second embodiment.

Referring to FIG. 5, after acquiring a deep-learning model from a sever 200 at step S410, a client 100 may perform changing the deep-learning model to be user-private at step S420, transmitting the hidden network of the deep-learning model changed to be user-private to the server at step S430, and storing the input network and output network of the user-private deep-learning model in memory as a secure input network and a secure output network at step S440.

Here, changing the deep-learning model at step S420 may comprise changing the order of the vector elements of the deep-learning model to the order set by a user and changing the order of weight elements by synchronizing the same with the changed order of the vector elements.

Referring to FIG. 6, configuration diagrams of an existing deep-learning model 10 and a deep-learning model 30 changed according to the embodiment are illustrated. Here, the deep-learning models, the networks of which are simplified, are illustrated for convenience of description, but without limitation thereto, the present disclosure may be applied to all deep-learning structures including an operation between the input vector of a layer and a weight matrix.

In the existing service deep-learning model 10, nodes are formed in the order of Blue (B), Red (R), and Green (G), and based thereon, weight elements to be added are listed in the order of a solid line, a dotted line, and a thick solid line. The deep-learning model 10 may include an input network 11, a hidden network 12 including N layers, and an output network 13.

The user-private secure model 30 according to the embodiment may be acquired by permuting the weight elements of the existing service deep-learning model 10. That is, the order of the nodes formed in the order of Blue (B), Red (R), and Green (G) and the order of adding the weights based thereon are changed to the orders arbitrarily set by the user.

Equation (1) below shows an example of an operation between input vector X and a weight matrix for one layer of the existing model network and vector Y that is output as the result of the operation.

$$[ \begin{matrix}{Y}_{1} \\ {Y}_{2} \\ {Y}_{3}\end{matrix} ] = [ \begin{matrix}{w}_{1 blue} & {w}_{1 red} & {w}_{1 green} \\ {w}_{2 blue} & {w}_{2 red} & {w}_{2 green} \\ {w}_{3 blue} & {w}_{3 red} & {w}_{3 green}\end{matrix} ] . [ \begin{matrix}{X}_{1} \\ {X}_{2} \\ {X}_{3}\end{matrix} ] \qquad ( 1 )$$

Here, a description of a nonlinear operation of the node will be omitted. Here, an example in which the weight element index connected to the first input node of the layer is blue, the weight element index connected to the second input node is red, and the weight element index connected to the third input node is green is illustrated.

Equation (2) shows the results of the elements of output vector Y.

$${Y}_{1} = {X}_{1} \times {w}_{1 blue} + {X}_{2} \times {w}_{1 red} + {X}_{3} \times {w}_{1 green} \qquad ( 2 )$$

$${Y}_{2} = {X}_{1} \times {w}_{2 blue} + {X}_{2} \times {w}_{2 red} + {X}_{3} \times {w}_{2 green}$$

$${Y}_{3} = {X}_{1} \times {w}_{3 blue} + {X}_{2} \times {w}_{3 red} + {X}_{3} \times {w}_{3 green}$$

In the embodiment, the order of the elements of the weight matrix is changed to be synchronized with the order of the elements of the input vector as shown in Equation (3) below:

$$[ \begin{matrix}{Y}_{2} \\ {Y}_{3} \\ {Y}_{1}\end{matrix} ] = [ \begin{matrix}{w}_{2 green} & {w}_{2 blue} & {w}_{2 red} \\ {w}_{3 green} & {w}_{3 blue} & {w}_{3 red} \\ {w}_{1 green} & {w}_{1 blue} & {w}_{1 red}\end{matrix} ] . [ \begin{matrix}{X}_{3} \\ {X}_{1} \\ {X}_{2}\end{matrix} ] \qquad ( 3 )$$

This means that, when the order of the elements of the input vector is changed, the vector itself is changed, so the order and locations of the weight elements have to be changed in order to maintain the operation structure. Also, the order of the elements of the output vector is changed, and then the result may be output.

That is, the network may be formed by permuting the elements of the input vector of the layer and also permuting the elements of the output vector. However, as shown in Equation (4) below, the equations for the elements of the output vector are the same as the equations for the elements of the output vector of the existing model shown in Equation (2).

$${Y}_{2} = {X}_{3} \times {w}_{2 green} + {X}_{1} \times {w}_{2 blue} + {X}_{2} \times {w}_{2 red} \qquad ( 4 )$$

$${Y}_{3} = {X}_{3} \times {w}_{3 green} + {X}_{1} \times {w}_{3 blue} + {X}_{2} \times {w}_{3 red}$$

$${Y}_{1} = {X}_{3} \times {w}_{1 green} + {X}_{1} \times {w}_{1 blue} + {X}_{2} \times {w}_{1 red}$$

That is, the value of Y₁ in Equation (2) is equal to the value of Y₁ in Equation (4). Therefore, the operations of the network and the values acquired through the operations are not changed, but the order of the vector elements is changed.

Unless the order of the elements of the weight matrix is synchronized with the order of the elements of the input vector, an erroneous operation is caused and wrong vector values are transferred. This makes it difficult to restore original data when the input vector of a user is transferred to a service company, because the order of the vector elements is not known even when the input vector is exposed. In order to guess the original data, it is necessary to find out the order corresponding to the dimension of the input vector, and if the dimension of the input vector is M, a number of cases equal to the factorial of M (M!) has to be considered. Here, when the dimension of 1024, which is commonly used for deep-learning, is applied, a number of operations corresponding to an almost infinite number of cases is required. This is also applied to the output vector of the hidden network, and because the final output network for the input data is present in the client, the result is transferred without exposing the output pattern. As described above, the entire deep-learning network from the input stage to the output stage is changed.

Because the network for finally interpreting the result is also reconfigured according to the order of weights set by the user, the result may be interpreted only in the client through a correct operation. That is, even though interpreting the result is attempted by stealing the vector value acquired by passing through the hidden network, if the order of the weight elements of the output network is not known, interpretation based on the correct operation result becomes impossible.

Here, changing the deep-learning model may comprise scaling all of the weights of the deep-learning model by multiplying the weights by constant A and adding constant B thereto. That is, in order to prevent reverse estimation and reconfiguration of the locations of the parameters of the existing model when the values of the weight parameters are exposed, all of the weights are scaled by applying different scalar values A and B to all layers by multiplying the existing weight matrix by A and adding B thereto. This is a method of changing the values of the weights while having no effect on the competitive weight elements, thereby preventing exposure of the weights of the existing model. This method may impose a burden to a server because the serve has to identify each client and provide a service for the client, but has an advantage in which a secure service is available without additional fine-tuning. Also, this method maintains security because the order of the weight elements for each layer is known only to the client. Therefore, the service may be provided without degradation in operation speed and performance, compared to the existing method for achieving security by performing homomorphic encryption on the entire network.

### Third Embodiment

FIG. 7 is a schematic signal flowchart for explaining a method for a secure online deep-learning model service according to a third embodiment.

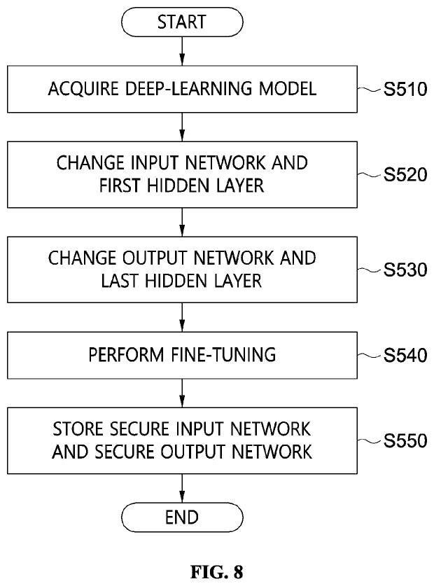

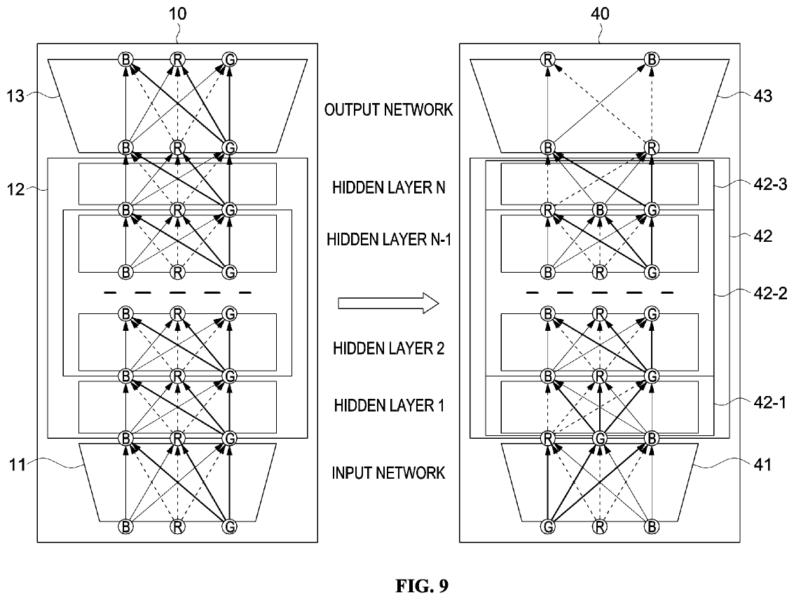

Referring to FIG. 7, in the method for a secure online deep-learning model service according to the third embodiment, a client 100 may generate a secure input network 41 and a secure output network 43 in advance based on a deep-learning model provided from a server 200. This will be described in detail later with reference to FIG. 8 and FIG. 9.

Subsequently, the client 100 performs generating an input vector by passing user data through the secure input network 41 and transmitting the input vector to the server 200. Here, the client 100 may change the order of the elements of the input vector output through the secure input network 41 so as to match the order of input to the fine-tuned user-private first hidden layer 42-1 in the server 200 and transmit the input vector through a transmission module 41-1.

Then, the server 200 performs generating an output vector by passing the input vector received from the client 100 through a hidden network 42 and transmitting the generated output vector to the client 100.

Here, the hidden network 42 may be formed by combining the fine-tuned user-private first hidden layer 42-1 and user-private last hidden layer 42-3 with the original common hidden network 42-2.

Here, the user-private first hidden layer 42-1 restores the order of the elements of the received input vector to the original order so as to match the order of input to the common hidden network 42-2, as illustrated in FIG. 9 to be described later, and transfers the same to the hidden network 42-2.

That is, in the method for a secure online deep-learning model service according to the third embodiment, the order of the elements of the input vector is changed when the input vector is transmitted from the client 100 to the server 200, and the order of the elements of the received input vector is restored to the original order of the elements in the user-private first hidden layer 42-1, whereby the common hidden network 42-2 can be used.

Then, the order of the elements of the output vector, output as the result of operation in the common hidden network 42-2, is changed in the user-private last hidden layer 42-3, after which the output vector is transmitted to the reception module 43-1 of the client 100.

Then, the reception module 43-1 of the client transfers the received output vector according to the order of input to the secure output network 43 by referring to the order of output from the fine-tuned user-private last hidden layer 42-3.

Accordingly, the common hidden network 42-2 is used, but the original vector may be prevented from being estimated even when data is exposed during transmission and reception between the client 100 and the server 200.

Here, the transmission module 41-1 of the client may perform an additional operation for permuting the vector elements or applying another encryption method as well as the operations of receiving the input vector from the secure input network 41, in which the order of the vector elements is changed because the order of weights is changed, and transmitting the input vector to the server.

Also, the reception module 43-1 of the client may perform an additional operation for permuting the vector elements or receiving the vector based on another decryption method as well as the operation of receiving the output vector according to the order of the vector elements of the last hidden layer 42-3.

FIG. 8 is a signal flowchart for explaining the step of generating a secure input network and a secure output network according to the third embodiment, and FIG. 9 is an exemplary view for explaining a change of the input/output network and hidden network of a deep-learning model according to the third embodiment.

Referring to FIG. 8, after acquiring a deep-learning model from a server 200 at step S510, a client 100 may perform changing the order of the vector elements of the input network of the deep-learning model and the order of the weight elements of a first hidden layer to an order set by a user by synchronizing the order of the vector elements with the order of the weight elements at step S520, reducing the number of nodes at which the input network meets the first hidden layer at step S520, changing the order of the weight elements of a last hidden layer and the order of the vector elements of the output network of the deep-learning model to an order set by the user by synchronizing the order of the weight elements with the order of the vector elements at step S530, reducing the number of nodes at which the last hidden layer meets the output network at step S530, changing the output unit of the output network to an output unit set by the user, generating a user-private output network in which the order of output nodes is an order set by the user, fine-tuning the deep-learning model using user data at step S540 in the state in which the hidden network, excluding the first hidden layer and the last hidden layer, is fixed, and storing the input network and the output network of the fine-tuned deep-learning model in memory as a secure input network and a secure output network at step S550.

In the third embodiment, the method of the first embodiment and the method of the second embodiment are mixed, whereby the secure input network 41 and the secure output network may be generated using a less amount of user data.

Also, the common hidden network provided by a service company is used, but the input and output by individual users may be protected.

Referring to FIG. 9, the first hidden layer 42-1 and the last hidden layer 42-3, which are changed to be user-private, have to be connected with the common hidden network model 42-2 provided by the service company.

Here, the weights of the existing output network may be reused by maintaining the weight value for the user output unit that matches the existing output unit.

Here, the server 200 combines the first hidden layer 42-1 and the last hidden layer 42-3, which are transmitted from the client 100 requesting fine-tuning, with the remaining part of the hidden network 42-2 and supports fine-tuning in the state in which the hidden network 42 is combined with the input network 41 and output network 43 of the client 100 online by being connected with the client 100 requesting fine-tuning.

Also, when fine-tuning is performed, a weight pruning technique is applied to the first hidden layer and the last hidden layer, whereby an attempt to estimate original data from exposed network gradients may be proactively prevented.

The above-described method may also be applied to a transformer, which is a deep-learning model that is most widely used these days.

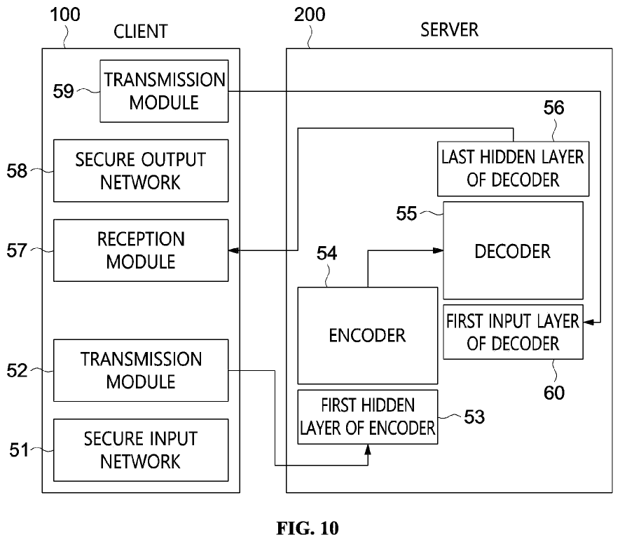

FIG. 10 is a schematic signal flowchart for explaining the case in which the method for a secure online deep-learning model service according to the third embodiment is applied to a transformer.

Referring to FIG. 10, a transformer model includes an input network 51, an encoder network 54, a decoder network 55, and an output network 58.

According to an embodiment, the first hidden layer 53 of the encoder network, the last hidden layer 56 of the decoder network, and the input layer 60 of the decoder network are user-private layers transmitted from a user, and may be fine-tuned using data corresponding to a user domain through a fine-tuning procedure provided by a service company or a fine-tuning procedure performed solely by a client.

For example, according to an embodiment, a server 200 may support fine-tuning after being combined online with the input network 51 and the output network 58 of the client 100 requesting fine-tuning by being connected with the client 100 in the state in which the first hidden layer 53 of the encoder network, the last hidden layer 46 of the decoder network, and the input layer 60 of the decoder network, which are user-private layers transmitted from the client 100 requesting fine-tuning, are combined with the encoder network 54 and the decoder network 55.

Here, the transformer model transfers the operation result to the output network 58 and receives the result from the output network as the input of the decoder network 55, thereby performing operation through sequential regression.

Accordingly, first generating an output vector through the encoder network 54 and the decoder network 55 combined with the first hidden layer 53 and the last hidden layer 56, which are fine-tuned by the client 100 that transmitted a first input vector, and again generating an output vector through the decoder network 55 combined with the input layer 60 and the last hidden layer 56, which are fine-tuned by the client 100 that transmitted a second input vector generated from the first generated output vector, may be performed according to an embodiment.

Here, again generating the output vector may be repeatedly performed.

That is, when an input vector is transferred to a transmission module 52 after the order of the elements thereof is changed in the secure input network 51 of the client 100, the transmission module 52 transmits the input vector to the first hidden layer 53 of the encoder network in the server 200 in order to provide a secure deep-learning model service.

Then, the order of the elements of the input vector is restored to the original order in the first hidden layer 53 of the encoder network in the server 200, and the input vector is transferred to the encoder network 54. Subsequently, the transferred input vector is processed through the operation in the encoder network 54 and the decoder network 55 and is then output. The output vector is transmitted to the client 100 after the order of the elements thereof is changed in the last hidden layer 56 of the decoder network.

The output vector received from the server 200 is transferred to the secure output network 58 via a reception module 57.

Here, the result output from the output network 58 is sent back to the input layer 60 added to the decoder network in the server 200 via a transmission module 59 after the order of the elements of the vector is adjusted.

Then, until a result corresponding to termination is obtained, operation through sequential regression is performed by sequentially passing through the transmission module 59, the input layer 60 of the decoder network, the decoder 55, the last hidden layer 56 of the decoder network, the reception module 57, and the secure output network 58.

### Fourth Embodiment

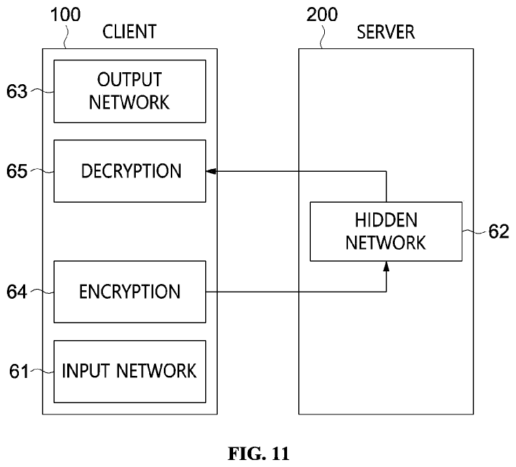

FIG. 11 is a schematic signal flowchart for explaining a method for a secure online deep-learning model service according to a fourth embodiment.

Referring to FIG. 11, in the method for a secure online deep-learning model service according to the fourth embodiment, a client 100 performs generating an input vector by passing user data through the input network 61 of a deep-learning model, performing homomorphic encryption on the input vector, and transmitting the input vector to a server 200. Here, the input network 61 and an output network 63 may be acquired in advance from the server 200.

Then, the server 200 performs generating an output vector by passing the input vector received from the client 100 through the hidden network 62 of the deep-learning model and transmitting the generated output vector to the client 100. Here, the server 200 has the hidden network on which homomorphic encryption using the encryption key distributed by a user has been performed.

Then, the client 100 decrypts the received operation result and interprets the same using the output network.

The structure described above is a method of allocating some of the layers of the hidden network to the client 100 in order to overcome the low operation speed of homomorphic encryption, and a service may be configured to reduce the number of layers of the hidden network run in the service server 200. Providing a service using this method impose a burden to the service company because the service company is required to generate a hidden network of a model corresponding to the encryption key of each user, but has an advantage in that a secure service may be provided without fine-tuning the provided model.

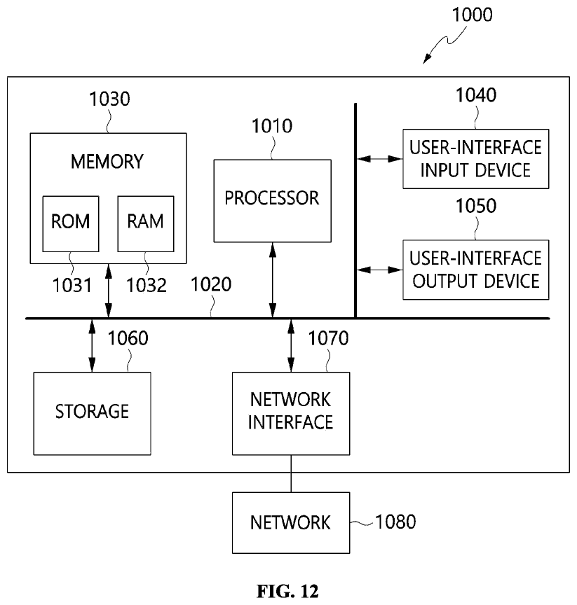

FIG. 12 is a view illustrating a computer system configuration according to an embodiment.

The apparatus for an online deep-learning model service according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, a company providing a deep-learning model as an online service may provide users with a service the does not expose personal information outside. Accordingly, users may fully use the service without concerns about information exposure.

According to the disclosed embodiment, the newest high-performance model provided by a service company can be used, and simultaneously, a service personalized to a user may be provided by fine-tuning user domain data.

According to the disclosed embodiment, an online deep-learning service may be used even in a financial field or a military and security field in which personal information is very sensitive.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A client apparatus for a secure online deep-learning model service, comprising:
memory in which a secure input network and a secure output network generated in advance based on a deep-learning model provided from a server and at least one program are recorded; and
a processor for executing the program,
wherein the program performs generating an input vector by passing user data through the secure input network,
transmitting the input vector to the server,
receiving an output vector, acquired by passing the input vector through a hidden network of the deep-learning model, from the server, and
generating output data by passing the received output vector through the secure output network.

2. The client apparatus of claim 1, wherein, when generating the secure input network and the secure output network, the program performs
fixing the hidden network of the deep-learning model provided from the server and changing an input network and an output network thereof to be user-private,
fine-tuning the deep-learning model using user-private data in a state in which the input network and the output network are changed, and
storing the input network and the output network of the fine-tuned deep-learning model in the memory as the secure input network and the secure output network.

3. The client apparatus of claim 2, wherein, when changing the input network and the output network, the program adds a user-private network to each of the input network and the output network and changes an output unit of the output network to an output unit set by the user.

4. The client apparatus of claim 1, wherein, when generating the secure input network and the secure output network, the program performs
changing the deep-learning model to be user-private,
transmitting a hidden network of the deep-learning model changed to be user-private to the server, and
storing an input network and an output network of the user-private deep-learning model in the memory as the secure input network and the secure output network.

5. The client apparatus of claim 4, wherein, when changing the deep-learning model, the program changes an order of vector elements of the deep-learning model to an order set by a user and changes an order of weight elements by synchronizing the order of the weight elements with the changed order of the vector elements.

6. The client apparatus of claim 5, wherein the program scales all of weights of the deep-learning model by multiplying the weights by constant A and adding constant B.

7. The client apparatus of claim 1, wherein:
when generating the secure input network and the secure output network, the program performs
changing an order of vector elements of an input network of the deep-learning model and an order of weight elements of a first hidden layer to an order set by a user by synchronizing the order of the vector elements with the order of the weight elements and reducing a number of nodes at which the input network meets the first hidden layer,
changing an order of weight elements of a last hidden layer and an order of vector elements of an output network of the deep-learning model to an order set by the user by synchronizing the order of the weight elements with the order of the vector elements and reducing a number of nodes at which the last hidden layer meets the output network,
changing an output unit of the output network to an output unit set by the user and generating a user-private output network in which an order of output nodes is an order set by the user,
fine-tuning the deep-learning model using user data in a state in which the hidden network, excluding the first hidden layer and the last hidden layer, is fixed, and
storing the input network and the output network of the fine-tuned deep-learning model in the memory as the secure input network and the secure output network, and
when receiving the output vector, the output vector is acquired by passing through the hidden network with which the first hidden layer and last hidden layer of the fine-tuned deep-learning model are combined.

8. The client apparatus of claim 1, wherein:
the program uses an input network and an output network of the deep-learning model provided from the server, rather than using the secure input network and the secure output network, and
the program further performs
performing homomorphic encryption on the input vector before transmitting the input vector to the server, and
decrypting the received output vector.

9. A server apparatus for a secure online deep-learning model service, comprising:
memory in which at least one program and a deep-learning model are recorded; and
a processor for executing the program,
wherein the program performs receiving a securely processed input vector from a client,
generating an output vector by passing the received input vector through a hidden network of the deep-learning model, and
transmitting the generated output vector to the corresponding client.

10. The server apparatus of claim 9, wherein the program is connected with a client requesting fine-tuning, thereby supporting fine-tuning in a state in which an input network and an output network of the client are combined with the hidden network online.

11. The server apparatus of claim 9, wherein:
the memory stores a hidden network transmitted from each of one or more clients, and
when generating the output vector, the output vector is generated through a hidden network transmitted by a client that transmits the input vector.

12. The server apparatus of claim 9, wherein:
the program combines a first hidden layer and a last hidden layer, transmitted from a client requesting fine-tuning, with remaining part of the hidden network and supports fine-tuning in a state in which an input network and an output network of the client requesting fine-tuning are combined with the hidden network online by being connected with the client, and
when generating the output vector, the program generates the output vector through the hidden network, including the first hidden layer and the last hidden layer that are fine-tuned by the client that transmits the input vector.

13. The server apparatus of claim 9, wherein:
the deep-learning model is a transformer model,
the program supports fine-tuning after being combined online with an input network and an output network of a client requesting fine-tuning by being connected with the client in a state in which a first hidden layer of an encoder network, a last hidden layer of a decoder network, and an input layer of the decoder network, which are transmitted from the client requesting fine-tuning, are combined with the encoder network and the decoder network,
when generating the output vector, the program performs
first generating the output vector through the encoder network and the decoder network combined with the first hidden layer of the encoder network and the last hidden layer of the decoder network that are fine-tuned by the client that transmits a first input vector, and
again generating the output vector through the decoder network combined with the input layer of the decoder network and the last hidden layer of the decoder network that are fined-tuned by the client that transmits a second input vector generated from the previously generated output vector, and
again generating the output vector is repeatedly performed.

14. A method for a secure online deep-learning model service, in which a secure input network and a secure output network are generated in advance based on a deep-learning model provided from a server, the method comprising:
generating an input vector by passing user data through the secure input network;
transmitting the input vector to the server;
receiving an output vector acquired by passing the input vector through a hidden network of the deep-learning model from the server; and
generating output data by passing the received output vector through the secure output network.

15. The method of claim 14, wherein the secure input network and the secure output network are generated by performing fixing the hidden network of the deep-learning model provided from the server and changing an input network and an output network of the deep-learning model to be user-private,
fine-tuning the deep-learning model using user private data in a state in which the input network and the output network are changed, and
storing the input network and the output network of the fine-tuned deep-learning model in memory as the secure input network and the secure output network.

16. The method of claim 15, wherein changing the input network and the output network comprises adding a user private network to each of the input network and the output network and changing an output unit of the output network to an output unit set by a user.

17. The method of claim 14, wherein the secure input network and the secure output network are generated in advance by performing
changing the deep-learning model to be user-private,
transmitting a hidden network of the deep-learning model changed to be user-private to the server, and
storing an input network and an output network of the user-private deep-learning model in memory as the secure input network and the secure output network.

18. The method of claim 17, wherein changing the deep-learning model comprises changing an order of vector elements of the deep-learning model to an order set by a user and changing an order of weight elements by synchronizing the order of the weight elements with the changed order of the vector elements.

19. The method of claim 14, wherein:
the secure input network and the secure output network are generated in advance by performing
changing an order of vector elements of an input network of the deep-learning model and an order of weight elements of a first hidden layer to an order set by a user by synchronizing the order of the vector elements with the order of the weight elements and reducing a number of nodes at which the input network meets the first hidden layer,
changing an order of weight elements of a last hidden layer and an order of vector elements of an output network of the deep-learning model to an order set by the user by synchronizing the order of the weight elements with the order of the vector elements and reducing a number of nodes at which the last hidden layer meets the output network,
changing an output unit of the output network to an output unit set by the user and generating a user-private output network in which an order of output nodes is an order set by the user,
fine-tuning the deep-learning model using user data in a state in which a hidden network, excluding the first hidden layer and the last hidden layer, is fixed, and
storing the input network and the output network of the fine-tuned deep-learning model in memory as the secure input network and the secure output network, and
when receiving the output vector, the output vector is acquired by passing through the hidden network with which the first hidden layer and last hidden layer of the fine-tuned deep-learning model are combined.

20. The method of claim 14, wherein:
an input network and an output network of the deep-learning model provided from the server, rather than the secure input network and the secure output network, are used,
the method further comprising:
performing homomorphic encryption on the input vector before transmitting the input vector to the server, and
decrypting the received output vector.
